(19) United States
(12) Patent Application Publication
(10) Pub. No.: US 2005/0222941 A1
(43) Pub. Date: Oct. 6, 2005

(54) System and method for trading restricted financial products

(75) Inventor: Robert Stanley Tull JR., Levittown, PA (US)

Correspondence Address: HOWREY SIMON ARNOLD & WHITE, LLP - OC, 301 RAVENSWOOD AVENUE, BOX 34, MENLO PARK, CA, 94025, US

(73) Assignee: The American Stock Exchange LLC, New York, NY (US)

(21) Appl. No.: 11/095,773

(22) Filed: Mar. 30, 2005

Related U.S. Application Data
(60) Provisional application No. 60/557,423, filed on Mar. 30, 2004.
(60) Provisional application No. 60/657,697, filed on Mar. 3, 2005.

(51) Int. Cl. G06F 17/60

(52) U.S. Cl. 705/37

(57) ABSTRACT

The invention allows trading on an exchange of non-taxable insurance funds and other financial products for which ownership and/or trading rights are restricted. In certain embodiments, the invention relates to systems and methods for validating and routing orders for restricted financial products. Other embodiments relate to systems and methods for trading restricted financial products in segregated areas of an exchange.

### CROSS REFERENCE TO RELATED APPLICATIONS

This application claims the benefit of priority to U.S. Provisional Patent Application Ser. No. 60/557,423, filed Mar. 30, 2004, entitled System and Method for Utilizing A Segregated Trading Area for Trading Financial Instruments, and to U.S. Provisional Patent Application Ser. No. 60/657,697, filed Mar. 3, 2005, entitled Exchange-traded Non-Taxable Funds. Both applications are incorporated herein by reference in their entireties.

### FIELD OF THE INVENTION

The invention generally relates to systems and methods to allow non-taxable financial instruments and other financial instruments with restricted ownership to be traded on public exchanges.

### BACKGROUND

As the complexities of assets have grown over the least twenty years, so have the complexities of ownership rights. Certain assets can only be held by qualified persons or under qualified legal structures. Deferred annuities from insurance companies being held in a tax-free manner for capital gains and income accumulation, hedge funds owned by qualified investors, and securities sold under Securities and Exchange Commission (SEC) Rule 144A are examples of such assets. As the uses of these products have expanded, so has the need for investors to be able to trade these products on exchanges. The term Restricted Financial Product (RFP) is used herein to refer to any financial products, including variable annuities, segregated pension fund assets, private placements to qualified investors, and other restricted securities and options contracts on those securities, that may only be owned and/or traded by certain qualified investors.

As already noted, insurance annuities are one example of RFPs. Insurance annuities are designed to convert a specific sum of money accumulated during an accumulation period into a series of periodic payments that are guaranteed for a period of time, the annuitization phase, which may be, for example, the lifetime of an individual. One benefit of annuities that make them popular investment instruments is that they are tax-deferred, that is investment gains are not taxed as they build value within the annuity. Because of their tax-deferred status, annuities are often preferable to savings accounts and other investments in which interest, capital gains, and dividends may be taxed as they are earned. Insurance annuities can only be created by insurance companies, and are purchased from banks, stock brokers, and insurance companies.

The Internal Revenue Service (IRS) has promulgated rules regulating ownership and trading of non-taxable and tax-deferred financial instruments. IRS rules forbid commingling within the same pooled investment vehicle of taxable and non-taxable financial products, including insurance annuities and other non-taxable financial products such as government bonds. These regulations have been a barrier to trading such products on organized exchanges, such as the American Stock Exchange (AMEX). The introduction of secondary market trading on an organized exchange of these products would allow for greater trading flexibility and price transparency throughout the day, as well as offering the opportunity for bringing buyers and sellers together, bringing enhanced liquidity to the products. There is thus a need for systems and methods that would allow trading of tax-exempt and tax-deferred financial products on organized exchanges without commingling those products with taxable financial products, in order to maintain compliance with IRS regulations.

Hedge funds are another example of RFPs. Hedge funds are investment funds that often take unconventional positions in securities, and unlike mutual funds and exchange-traded funds, hedge funds are typically not registered under the Investment Company Act and their holdings are typically not registered under the Securities Exchange Act. Because they are not registered, they are not typically subject to reporting requirements, and investment in hedge funds is therefore limited to authorized investors such as wealthy individuals and institutional investors. Limitations as to who can buy shares of hedge funds have been a barrier to trading of shares of hedge funds on organized exchanges. There is thus a need for systems and methods to allow trading of hedge fund shares on organized exchanges between authorized investors while preventing unauthorized investors from trading hedge fund shares.

Other examples of RFPs include securities sold under SEC Rule 144A (so-called “restricted securities”), which allows buying and selling of securities that are exempt from SEC registration requirements. Like hedge funds, trading of restricted securities is not open to the general public and they are thus not traded on organized exchanges, which makes these securities less liquid than they would otherwise be. There is thus a need for systems and methods to allow trading of securities sold under SEC Rule 144A on organized exchanges between authorized investors while preventing unauthorized investors from trading in those securities.

The above examples of RFPs are not limiting. As known to those in the financial industry, there are other types of securities that various statutes and regulations prevent from being owned and/or traded by the general public. These statutes and regulations are barriers that currently prevent RFPs from trading on organized exchanges, despite the general need in the financial industry for liquidity. Thus, there is a need in the financial industry for systems and methods to allow trading of RFPs on organized exchanges.

### SUMMARY OF THE INVENTION

The present invention provides systems and methods that allow RFPs to trade on organized exchanges by (1) processing trading orders to determine whether the subject of a trading order is an RFP, and if so, (2) verifying that the investor, broker, and/or firm placing a trading order is authorized to trade the RFP, and (3) directing the trading order for the RFP to a segregated environment within an exchange.

One embodiment of the invention is a method to allow exchange-trading of financial products with restricted ownership rules, comprising: receiving an order on a computer system to buy or sell shares of a financial product with restricted ownership rules, wherein the order is an electronic file comprising data indicating the identity of the financial product and the identity of the entity placing the order; retrieving data from an electronic database, wherein the data from the electronic database contains information sufficient to determine, from among a plurality of entities and a plurality of restricted financial products, which entities are authorized to trade in which restricted financial products; comparing the identity of the financial product and the identity of the entity placing the order with the data from the electronic database; verifying that the entity placing the order is authorized to trade in the financial product with restricted ownership rules; and electronically routing the order to a segregated trading area within the exchange, wherein only shares of the financial product with restricted ownership rules trade within the restricted trading area. In some embodiments, data from the electronic database comprises information about which firms are authorized to trade in the financial product with restricted ownership rules. In some embodiments, data from the electronic database comprises information about which firm branches are authorized to trade in the financial product with restricted ownership rules. In some embodiments, data from the electronic database comprises information about which brokers are authorized to trade in the financial product with restricted ownership rules. In some embodiments, the financial product with restricted ownership rules is an exchange-traded insurance fund. In some embodiments, the firm verifies that a customer placing an order to buy or sell shares of the financial product with restricted ownership rules is authorized to own shares of the financial product. In some embodiments, the firm verifies that a customer placing an order to buy shares of the financial product with restricted ownership rules uses funds that are permitted for use to buy shares of the financial product with restricted ownership rules. In some embodiments, the financial product with restricted ownership rules is an exchange-traded insurance fund, and the funds that are permitted for use to buy shares of the exchange-traded insurance fund are funds from an insurance annuity. In some embodiments, a specialist fulfills orders for shares of the exchange-traded insurance fund, and wherein the specialist causes the creation of shares of the exchange-traded insurance fund when the specialist's inventory of shares of the exchange-traded insurance fund are insufficient to fill orders for shares of the exchange-traded insurance fund.

In another embodiment, the invention comprises system to allow exchange-trading of financial products with restricted ownership rules, comprising a computer system with: an order receiving module for: receiving an order on a computer system to buy or sell shares of a financial product with restricted ownership rules, wherein the order is an electronic file comprising data indicating the identity of the financial product and the identity of the entity placing the order; an electronic database, wherein the data from the electronic database contains information sufficient to determine, from among a plurality of entities and a plurality of restricted financial products, which entities are authorized to trade in which restricted financial products; a verification module for: retrieving data from the electronic database, comparing the identity of the financial product and the identity of the entity placing the order with the data from the electronic database; and verifying that the entity placing the order is authorized to trade in the financial product with restricted ownership rules; and an order routing module for: electronically routing the order to a segregated trading area within the exchange, wherein only shares of the financial product with restricted ownership rules trade within the restricted trading area. In some embodiments, data from the electronic database comprises information about which firms are authorized to trade in the financial product with restricted ownership rules. In some embodiments, data from the electronic database comprises information about which firm branches are authorized to trade in the financial product with restricted ownership rules. In some embodiments, data from the electronic database comprises information about which brokers are authorized to trade in the financial product with restricted ownership rules. In some embodiments, the financial product with restricted ownership rules is an exchange-traded insurance fund. In some embodiments, the firm verifies that a customer placing an order to buy or sell shares of the financial product with restricted ownership rules is authorized to own shares of the financial product. In some embodiments, the firm verifies that a customer placing an order to buy shares of the financial product with restricted ownership rules uses funds that are permitted for use to buy shares of the financial product with restricted ownership rules. In some embodiments, the financial product with restricted ownership rules is an exchange-traded insurance fund, and the funds that are permitted for use to buy shares of the exchange-traded insurance fund are funds from an insurance annuity. In some embodiments, a specialist fulfills orders for shares of the exchange-traded insurance fund, and wherein the specialist causes the creation of shares of the exchange-traded insurance fund when the specialist's inventory of shares of the exchange-traded insurance fund are insufficient to fill orders for shares of the exchange-traded insurance fund.

In another embodiment, the invention comprises a computer software program product residing on a computer readable medium to allow exchange-trading of financial products with restricted ownership rules, comprising instructions for causing a computer system to: receive an order to buy or sell shares of a financial product with restricted ownership rules, wherein the order is an electronic file comprising data indicating the identity of the financial product and the identity of the entity placing the order; retrieve data from an electronic database, wherein the data from the electronic database contains information sufficient to determine, from among a plurality of entities and a plurality of restricted financial products, which entities are authorized to trade in which restricted financial products; compare the identity of the financial product and the identity of the entity placing the order with the data from the electronic database; verify that the entity placing the order is authorized to trade in the financial product with restricted ownership rules; and electronically route the order to a segregated trading area within the exchange, wherein only shares of the financial product with restricted ownership rules trade within the restricted trading area. In some embodiments, the data from the electronic database comprises information about which firms are authorized to trade in the financial product with restricted ownership rules. In some embodiments, the data from the electronic database comprises information about which firm branches are authorized to trade in the financial product with restricted ownership rules. In some embodiments, the data from the electronic database comprises information about which brokers are authorized to trade in the financial product with restricted ownership rules. In some embodiments, the financial product with restricted ownership rules is an exchange-traded insurance fund. In some embodiments, the firm verifies that a customer placing an order to buy or sell shares of the financial product with restricted ownership rules is authorized to own shares of the financial product. In some embodiments, the firm verifies that a customer placing an order to buy shares of the financial product with restricted ownership rules uses funds that are permitted for use to buy shares of the financial product with restricted ownership rules. In some embodiments, the financial product with restricted ownership rules is an exchange-traded insurance fund, and the funds that are permitted for use to buy shares of the exchange-traded insurance fund are funds from an insurance annuity.

### BRIEF DESCRIPTIONS OF THE DRAWINGS

FIG. 1 is a block diagram illustrating the basic components and their connectivity in one embodiment of the invention.

FIG. 2 is a block diagram illustrating the basic components of one embodiment of the validation module.

FIG. 3 is a block diagram illustrating segregated trading areas within a trading environment.

FIG. 4 is an example of a format for a data structure containing order information.

FIG. 5 is a flow diagram illustrating one embodiment of the logic of the validation module.

FIG. 6 is a flow diagram illustrating one embodiment of a method for trading RFPs.

FIG. 7 is a flow diagram illustrating one embodiment of a method for creating shares of non-taxable ETIFs.

FIG. 8 is a flow diagram illustrating one embodiment of a method for redeeming shares of a non-taxable ETIFs.

### DETAILED DESCRIPTION

Embodiments of the present invention include methods for trading securities in a segregated environment within an exchange, where the segregated environment may include either electronic or physical locations, or both. The invention may be used with fully automated trade execution, with traditional auction marketplaces, or with any combination of the two. Various segregated environments may be made available for various types of RFPs. For example, a segregated environment may include a non-taxable space where variable annuity funds (e.g., exchange-traded insurance funds or other securities) can be traded under applicable Internal Revenue Service (IRS) and Securities and Exchange Commission (SEC) regulations. Some embodiments relate to a validation module configured to validate authorized trading of non-taxable securities or other RFPs in a segregated environment. The following description is of one embodiment of the invention wherein the RFP described is a tax-deferred exchange-traded insurance fund (ETIF). However, as will be immediately recognized by those familiar with the financial industry, closely related systems and methods may be used for trading other types of RFPs, including, for example, derivative contracts based on ETIFs and other RFPs, with only minor modifications or variations, if any. The examples described herein are not intended to be limiting.

Under the Internal Revenue Code (IRC), Section 817(h), in order to benefit from favorable tax-deferred status, variable insurance annuities and life insurance policies must be adequately diversified, i.e., no single investment may comprise a significant majority of the invested assets. However, Section 817(h)(4) and Treasury Regulation § 1.817-5 provide that diversification may be achieved by investment in a single investment company (i.e., a fund) whose assets are adequately diversified. But the Treasury Regulations restrict who can invest in such funds and still allow the fund to retain its ability to satisfy the diversification requirements for an insurance annuity investment and to retain its tax deferred status. Thus, such a fund may not be owned by members of the general public, but rather may only be owned by certain permitted investors, such as the owner of an insurance annuity contract with its assets invested in the aforementioned investment company. While such insurance funds are not currently traded on exchanges, the present inventions would allow such insurance funds to trade on exchanges, and thus an insurance fund that is traded on an exchange using the systems and methods described herein is referred to as an exchange-traded insurance fund (ETIF).

Restrictions in ownership of investment funds held by insurance annuities thus currently prevent these RFPs from being traded on secondary markets such as public stock exchanges because public exchanges do not currently determine whether a customer ordering a trade is authorized to make that trade. Thus, in one embodiment, the invention includes a validation system and method to verify that an investor who places an order for an RFP is qualified to own the RFP and to exclude unqualified investors. Part of the validation system may include a validation module as a computer program product that provides instructions to a computer system for receiving orders and verifying that the entity placing the order is a qualified investor or represents a qualified investor. In one embodiment, the invention includes a segregated trading area within an exchange wherein qualified investors can trade RFPs, but in which unqualified investors may not conduct transactions.

There are securities currently trading on exchanges that are not suitable for all investors (e.g., options), and the onus is on the broker to ensure that the customer only transacts in an appropriate investment (the so-called “know your customer” rule). However, this rule is an insufficient protection against unauthorized investment in ETIFs because if a broker improperly puts a customer's taxable assets into an ETIF, that would not only impact the customer and the broker, but all investors in the ETIF by potentially disqualifying its tax-favored status. The situation is similar for hedge funds and other RFPs, and thus it is important to have a safeguard at the exchange level, as with the present invention.

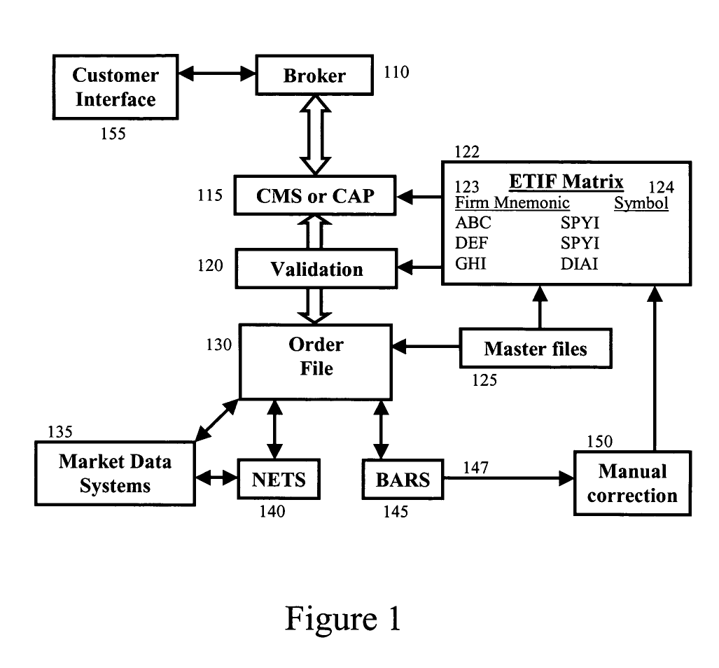

FIG. 1 is a block diagram illustrating one embodiment of the invention involving trading ETIFs on an organized exchange such as the AMEX. Certain modifications to existing exchanges should be made in order to accommodate trading of RFPs. Such modifications include order validation in order to verify that an entity requesting a new order is authorized to place that order. The validation system is desirably based upon mnemonic codes like those presently used by exchanges and registered with the Securities Industry Automation Corporation (SIAC) to identify brokers who conduct transactions within an exchange, except that new mnemonic codes will preferably be used in order to identify firms authorized to conduct transactions involving RFPs.

A qualified customer may place an order with a broker 110. In some embodiments, the qualified customer may place the order with the broker through a proprietary order system 155, embodiments of which are described below. The broker may be pre-authorized by the exchange to conduct transactions in ETIFs on behalf of qualified customers. The broker sends the order to the Common Message Switch (CMS) 115 or to the central access point (CAP) of the exchange, thus initiating a transaction request within the exchange. In alternative embodiments, the broker may send the order to a portal that only accepts orders for a particular RFP, and rejects orders for non-restricted securities.

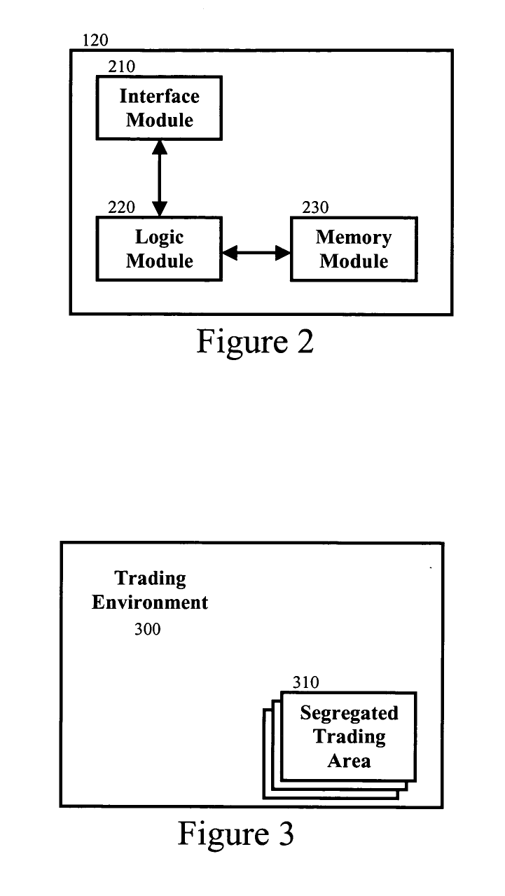

A validation module 120 that may comprise a computer software program with instructions to a computer system for processing incoming orders may be used to process the order. FIG. 2 provides a detailed block diagram of an embodiment of the validation module 120. The validation module 120 may include an interface module 210, a logic module 220 and a memory module 230. The interface module 210 may be any structure capable of interfacing with the CMS and/or CAPS systems, and possibly to other systems, and is preferably a network connection capable of receiving and transmitting data between the CMS and/or CAPS systems. For example, the interface module 210 may include a connection to a network that is accessible to the CMS and/or CAPS systems, as well as to brokers who place orders on the exchange. The logic module 220 may be any structure capable of performing the validation steps described herein, and is preferably a computer system with a microprocessor. The memory module 230 may be any structure capable of providing information required by the logic module for performing its function, and is preferably a data storage device such as random access memory, a computer hard drive, or any other type of electronic data storage media.

In one embodiment, the validation module 120 may be configured to determine whether an incoming trading order is eligible for the segregated trading environment. The interface module 210 may be configured to receive trading orders from within and/or outside an electronic trading environment. The logic module 220 may extract codes from the trading order to determine eligibility of the trading order for a segregated trading environment. If the logic module 220 determines that the trading order is ineligible for the segregated trading environment, the validation module 120 may forward the trading order to the taxable trading area.

The memory module 230 may be configured to store sets of predetermined codes, e.g., eligible broker codes and financial product codes. The logic module 220 may retrieve the sets of predetermined codes to compare the extracted codes from the trading order. In some embodiments, the memory module 230 may be an interface to an existing database storing the sets of predetermined codes.

The validation module may be configured to determine whether a received order is eligible for trading in the segregated environment by comparing data provided in the order with data 122 maintained by the exchange in a Master file database module 125. The Master file module 125 may contain data comprising descriptions of all types of securities traded on the exchange, including all RFPs and non-RFPs traded on the exchange. In one embodiment, the Master file database 125 may reside in the memory module 230. In other embodiments, the Master file database 125 may reside in a separate data storage device on a computer system. The descriptions in the Master file database may be maintained by an organized exchange, e.g., the American Stock Exchange, and Securities Industry Automation Corporation (“SIAC”) or other entities. The Master file module 125 may further contain data comprising descriptions of brokerage firms that are members of the exchange and conduct transactions on the exchange, and what types of transactions each brokerage firm is authorized to conduct.

The validation module may extract a firm mnemonic code 123 and/or financial product code symbols 124 from the order. The firm mnemonic code associated with the order may be compared to the Master file database 125 of firm mnemonic codes of brokerage firms 110 authorized to conduct transactions in the exchange on behalf of qualified customers in order to verify that the broker 110 is authorized to conduct the requested transaction. In this way, the exchange need only maintain a database of brokerage firms rather than a much larger and more complex database of qualified customers. In this embodiment, each individual brokerage firm would maintain its own database of qualified customers. Alternatively, the exchange may maintain a database of qualified customers and use this database in the validation step.

Similarly, the financial product code symbol 124 associated with the order may be compared to the Master file database 125 of financial product code symbols 124 maintained by the exchange in order to verify that the financial product that is the subject of the requested transaction is a qualified financial product, an ETIF in this example.

If the validation logic of the validation module 120 determines that the received order is eligible, the validation module 120 routes the received order to the segregated environment, which is illustrated schematically in FIG. 3. Otherwise, if the validation module 120 determines that the received order is ineligible for the segregated environment, the validation module may deny further routing of the received order. In certain embodiments, the validation module may return the received order to the sender with a message explaining the denial of further processing of the received order. In some embodiments, there may be multiple segregated trading areas 310 for trading of multiple types of RFPs, for example, there may be a segregated trading area for trading ETIFs, and a separate segregated trading area for trading securities sold under SEC Rule 144A. Each of the segregated trading areas may be located within the trading environment 300 of an exchange.

The trading environments 300 and 310 may be physical and/or logical (electronic) areas for trading of financial products. For example, they may comprise a physical space in which investors, specialists, market makers, and other market participants buy and sell shares of securities based on verbal agreements. Or they may comprise one or more computer systems running automated trading software for automatic execution of trades. In one embodiment, separate computer systems are used for each of the segregated trading areas and another different computer system is used for the non-segregated (public) trading environment. In other embodiments, a single computer system is used for multiple trading environments. In some embodiments, a separate trading area is assigned to each RFP. In a preferred embodiment, the various trading areas have both a physical and an electronic component, for a combination of verbal and electronic trading.

If the validation module 120 determines that a trading order is eligible for a segregated trading environment 310, the validation module 120 may place a flag on the trading order, which is then added to an Order File 130 database and is then transferred to the segregated trading environment 310. The Order File 130 may be considered as a staging area for received orders to be processed by members of the trading environment 300. The Order File 130 may also buffer messages associated with trading orders, e.g., confirmation messages, executed messages, pricing updates, etc. In other embodiments, the validation module 120 may directly forward the trading order to the segregated trading area 310.

In a preferred embodiment, the Order File 130 may interface with a new equity trading system (NETS) 140 and/or a booth automated routing system (BARS) 145. The NETS 140 provides an electronic interface for specialists to record changes to their equity books. The BARS 145 provides an electronic interface for market makers to interact with the trading environment. Under current IRS regulations, market makers would generally be barred from making trades in a trading area segregated for ETIFs, thus, in one embodiment, a separate validation module (not shown) may interfaced with the BARS 145 to prevent any such transactions. In other embodiments, the BARS 145 may interface with a single validation module 120, which may perform the validation of trading orders from a central location.

The Order File 130 may be further configured to interface with a market data system 135, which provide an interface for users of the trading environment 300 to be updated with the prices of orders, current prices, or other similar types of information. In some embodiments, the invention may include a pricing module for determining a per-share price of the ETIF based on the bid and ask prices and/or on the net asset value (NAV) of the securities underlying the ETIF.

If the order is not executed for any reason, it may be resubmitted through the trading process as described above. For example, if the order requests a trade at a specific price, but that price is not available on the market, the order may be stored in the specialist's order book or it may be continuously resubmitted until the market price is the same as the order price. An order may also fail to execute if there is some mistake in the order. In this case, a manual review 150 of the order may be necessary. Any error can then be manually corrected 150 with consultation and consent of the broker 110 who placed the order, and the corrected order may then be resubmitted.

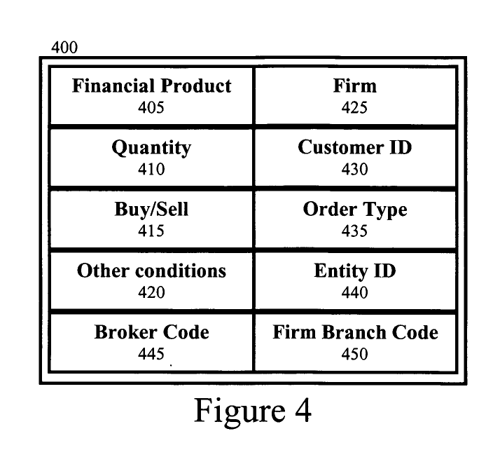

FIG. 4 provides an example of a trading order 400 for an RFP in accordance with some embodiments of the invention. In this embodiment, the trading order 400 is an electronic data file containing data specifying certain properties of the order and its origination. The format of a trading order may be implemented as, for example, a data structure when used with a computer based process to electronically route orders.

As shown in FIG. 4, the trading order includes a field 405 that identifies the restricted financial product, a field 410 that specifies the quantity of the financial product to be traded, a field 415 that specifies whether the order is a buy or sell order, and other conditions 420 (such as number of shares to be traded, a dollar amount for the trade, and date and time of execution of trade). The order format can include information on order origination such as a code identifying the stockbroker 445 placing the order, a firm identification field 425 identifying the brokerage firm from which the order originates, and a customer identifier 430, and may also include, for example account numbers and confirmation numbers. The trading order 400 may include a field 435 for an order type, for example, as a tax-exempt special treatment order or a normal order. The order format may also include a field 440 to identify the entity that forwarded the order to the exchange. The trading order 400 may further include a firm branch code 450 for identifying the branch of the firm placing the order. For example, a firm branch code 450 may identify the firm branch as being the insurance branch or the stock brokerage branch of a firm with two such branches, which may be used to determine whether the branch of the firm placing the order is eligible to trade in an RFP such as an ETIF.

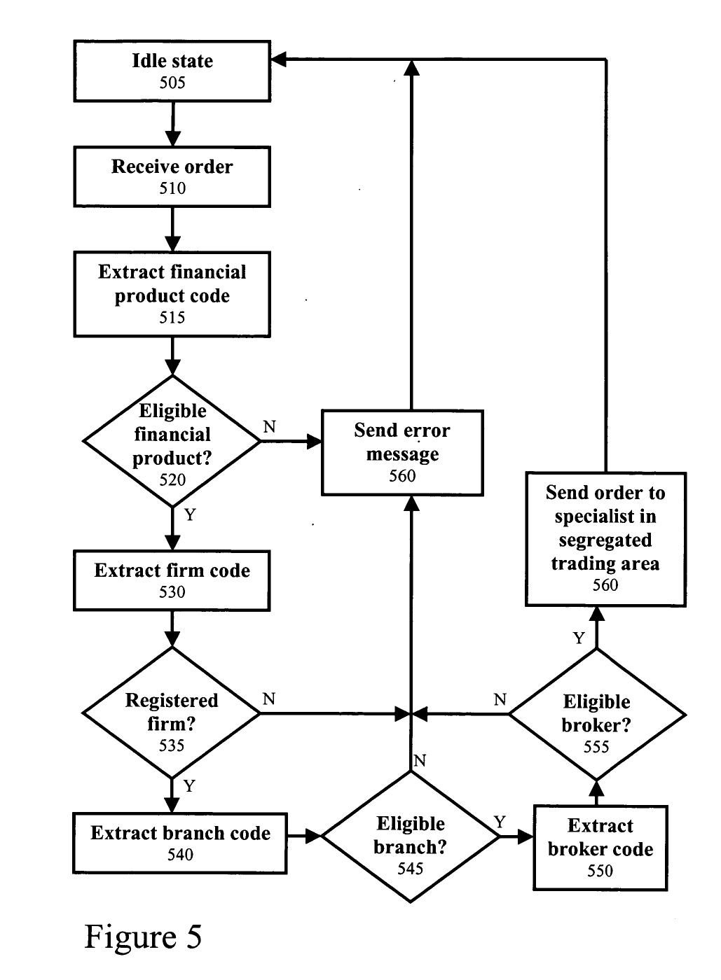

FIG. 5 is a flow diagram of one embodiment of the method implemented by the logic module 220 of the validation module 120 (shown in FIGS. 1 and 2). The validation logic as depicted in FIG. 5 tests whether the financial product is a qualified RFP and whether the brokerage firm, the firm branch, and the individual broker are all qualified to trade a particular RFP, for example, an ETIF. The method depicted in FIG. 5 shows a particular order for the extraction and testing steps in this method, but these steps may be performed in any order. Furthermore, the particular testing steps depicted in FIG. 5 are exemplary, and in principle any or all of these steps could be omitted, expanded, or substituted with other testing steps as the market matures or the asset classes are expanded.

As shown in FIG. 5, in step 505 the validation module 120 begins in an idle state. In step 510, the validation module 120 receives an incoming trading order through the interface module 210. It the embodiment shown in FIG. 5, the incoming trading order has been marked for trading in a segregated trading area. Ordinary (non-RFP) orders not destined for the segregated trading area may be handled in the traditional fashion, and need not be routed through the validation module. In some embodiments, the validation module 120 executes a query function call to determine whether a trading order has been received at the CMS and/or CAP interfaces 115. In other embodiments, the CMS and/or CAP interfaces 115 may be configured to forward incoming trading orders to the validation module 120.

In step 515, the validation module 120 extracts a financial product code 405 from the received trading order 400 and compares the financial product code 405 against the list of eligible financial products contained in the Master files database 125. In some embodiments, the list of eligible financial products may be stored as a file, a database, a linked list or other similar data structure in the memory module 230 (shown in FIG. 2).

In step 520, the logic module 220 determines whether the retrieved financial product code 405 in the order 400 represents a financial product eligible for trading in the segregated trading environment. In step 525, if the financial product is not eligible for the segregated trading environment, the logic module 220 may generate an appropriate error message, which is routed through the interface module to the sender of the received order, indicating that the identified financial product is not eligible for the segregated trading environment. Subsequently, the logic module 220 may return to the idle state of step 505.

Otherwise, if the logic module 220 determines that the retrieved financial product code 405 represents a security that is eligible to trade in the segregated trading environment 310, then in step 530, the logic module 220 retrieves a firm code 425 from the received trading order 400 and compares the retrieved firm code 425 against a list of firms registered to conduct transactions on the exchange. In various embodiments, the list of eligible firms may be stored as a database, a file, linked list or other similar data structure in the memory module 230. In some embodiments, the list of eligible brokers may be stored in the Master file module 125.

In step 535, the logic module 220 determines whether the retrieved firm code 425 corresponds to a firm registered to conduct transactions within the exchange. If the retrieved firm code corresponds to a firm not registered to conduct transactions on the exchange, the logic module 120 may generate an appropriate error message 560 to the sender of the order indicating that the firm is not eligible to conduct transactions on the exchange. Subsequently, the logic module 120 returns to the idle state of step 505.

Otherwise, if the retrieved code matches an entry in the list of registered firms maintained, for example, in the Master files database 125 or the memory module 230, the logic module proceeds to step 540. In step 540, the logic module 220 extracts the firm branch code 450 from the trading order 400. In some embodiments, a firm may be eligible to directly trade in the segregated trading environment, for example, by complying with the applicable IRS regulations in order to trade in ETIFs. In these embodiments, the firm branch code may be the same as the firm code. In other embodiments, a firm may create a subsidiary, affiliate, or other similar business entity to trade in the segregated trading environment in order to comply with IRS regulations. The subsidiary (or branch) firm should then have a separate code 450 from the parent firm to qualify to trade in the segregated trading environment. A firm may include several branches, each with its own branch code, for trading in a variety of different segregated environments. For example, a firm may have an insurance branch for trading in ETIFs and other non-taxable securities, and it may have a Rule 144A branch, for trading Rule 144A securities.

In step 54, the logic module 120 determines whether the firm branch corresponding to the retrieved firm branch code 450 is eligible to trade in the segregated trading environment. For example, the logic module 120 may designate a match between the retrieved firm branch code and an entry in the list of eligible firm branches. If the firm branch is not eligible because of a failure to designate such a match, then the validation module 120 may be configured to transmit an appropriate error message 560 to the sender of the received order indicating that the firm branch is not eligible for trading in the segregated trading environment.

Otherwise, if the logic module 120 determines that the firm branch is eligible, then in step 550, the logic module 120 extracts the broker code 445 from the received order 400. The broker code 445 is then compared to a list of brokers eligible to conduct transactions in the segregated trading environment. In step 555, the validation module 120 determines whether the retrieved broker code is eligible for trading in the segregated trading environment. The validation module 120 may match the retrieved broker code with an entry on the list of eligible brokers stored, for example, in the Master file module 125. In other embodiments, the list of eligible brokers may be stored as a file, a database, linked list or other similar data structure in the memory module 230.

If the validation module 120 determines that the retrieved broker code does not correspond to a broker eligible to conduct transactions in the segregated trading area, then the logic module 220 may generate an appropriate error message 560 for the sender of the received order indicating that the broker is not eligible for trading in the segregated trading environment. Subsequently, the validation module 120 may return to the idle state of step 505.

Otherwise, if the validation module 120 determines that the retrieved broker code corresponds to an eligible broker, in step 560, the validation module 120 forwards the received order 400 to the segregated trading environment for processing by a specialist. Subsequently, the validation module 120 returns to the idle state of step 505.

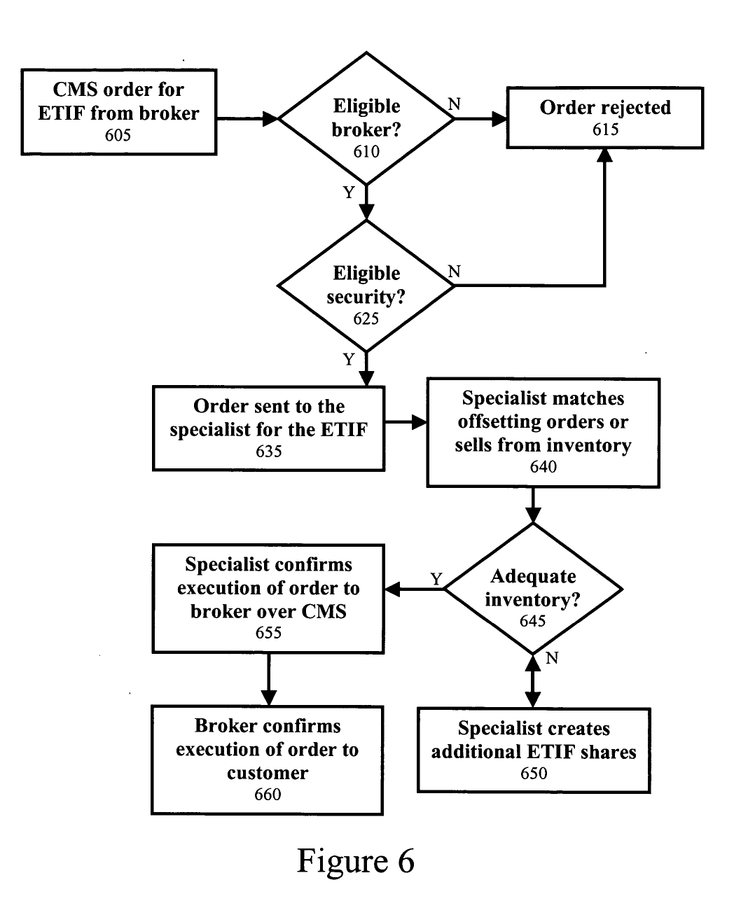

FIG. 6 is a flow diagram illustrating one embodiment of a method of the invention for trading non-taxable ETFs. While certain steps are shown in FIG. 6, it should be noted that certain other possible steps have not been depicted, that not all the steps in FIG. 6 may be necessary for carrying out methods of the invention, and that the order of the steps depicted in FIG. 6 is not necessary to practice the invention.

In step 605, an order for the purchase of a non-taxable ETF is received at the CMS from a broker authorized to trade in non-taxable ETFs. The broker's authorization to trade in non-taxable ETFs is verified in step 610, and if the broker were not so authorized, the order is rejected in step 615. The broker verification process is described above in detail with reference to FIG. 5, which describes a more intricate verification process including verification of the firm and firm branch. Once the broker is verified, in step 625, the security that is the subject of the order is verified as a non-taxable ETF that may be traded in the segregated environment. If the security is not for a non-taxable ETF, the order is rejected 615.

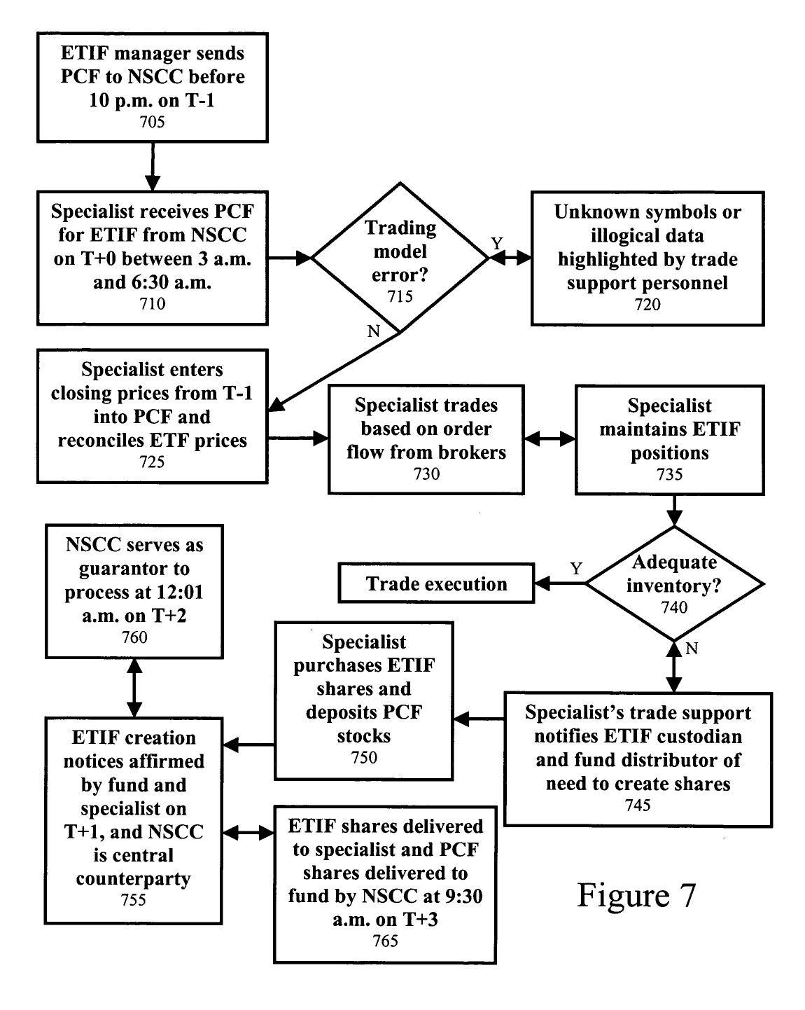

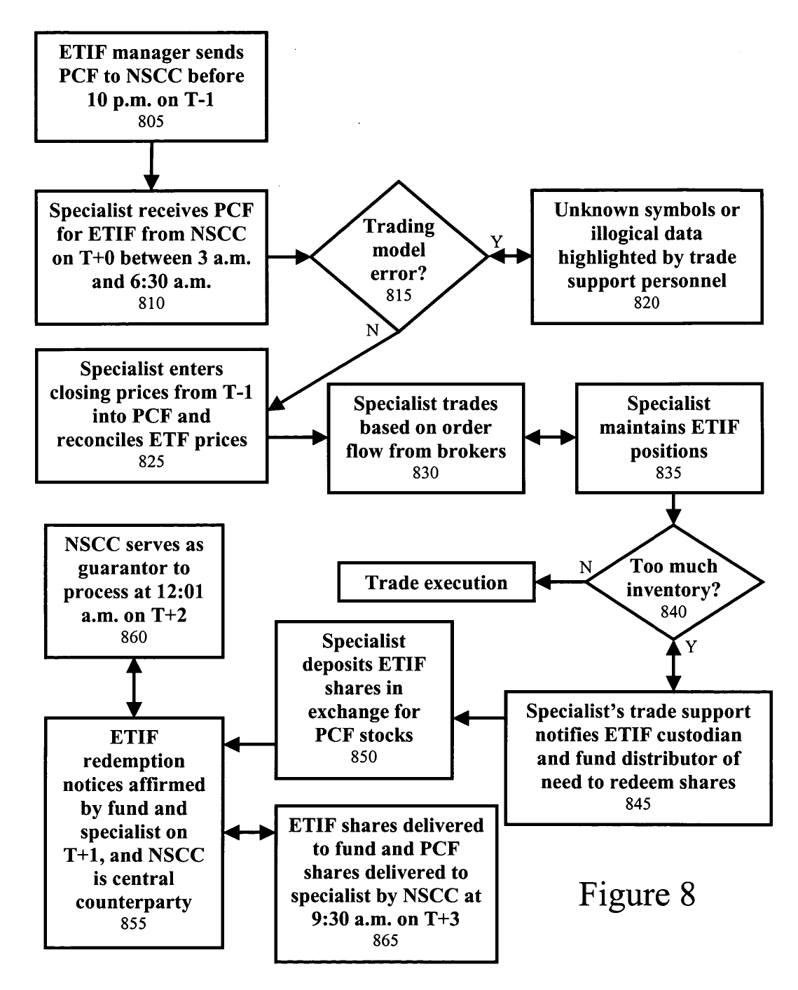

In step 635, once the broker and the security have been verified, the order is sent to the segregated trading area of the exchange, where it is passed to the floor specialist for that non-taxable ETF. The specialist then matches offsetting orders in step 640 if offsetting orders exist (for example, an order to buy a certain number of shares may be offset against an order to sell that many or more shares). Otherwise, the specialist may sell shares from the specialist's inventory, if the inventory balance 645 allows. If there are no offsetting orders and the specialist's inventory is insufficient to provide the shares requested in a buy order, the specialist may create additional non-taxable ETF shares in step 650 by creating shares using the National Securities Clearing Corporation (NSCC), as described in detail below with reference to FIG. 7. Similarly, if the order is a sell order and the specialist does not want additional shares of the non-taxable ETF in the specialist's inventory, then the specialist may redeem shares through a redemption process described below in detail with reference to FIG. 8.

After the specialist has fulfilled the order, in step 655 the specialist sends confirmation of the execution of the order over the CMS or CAP to the authorized broker who placed the order, who then sends confirmation of the execution of the order in step 660 to the customer who bought (or sold) the shares of the non-taxable ETF. Details of the trade may also be sent to the fund company, which can then update its records to reflect the new ownership of the traded shares.

FIG. 7 is a flow diagram illustrating one embodiment of a process for creation of shares of a non-taxable (e.g., insurance) ETF. This diagram is for illustrative purposes only. Additional steps may be added, or some steps may be omitted or modified, without departing from the method of the invention. Furthermore, while the process described with respect to FIG. 7 uses non-taxable ETFs as an example, those with knowledge of the financial industry will appreciate that similar or identical processes may be used with other types of RFPs, especially with RFPs that are ETFs. Similar methods for creation (FIG. 7) and redemption (FIG. 8) of shares of non-taxable ETFs are currently practiced for the creation and redemption of shares of ETFs, as known to those in the financial industry, and as described in U.S. patent application Ser. No. 10/753,069, entitled “Systems and Methods For Trading Actively Managed Funds”, filed on Jan. 8, 2004, which is hereby incorporated by reference in its entirety. Under typical circumstances, a specialist or arbitrageur will create shares of a non-taxable ETF if the market price of the ETF exceeds the net asset value of the ETF by more than the transaction cost of creating shares of the ETF.

In step 705, the investment manager of a non-taxable ETF sends a portfolio creation file (PCF) to the NSCC prior to 10 p.m. on the day before a trading day (T-1) for use in the purchase and redemption of shares of the non-taxable ETF on the trading day (T+0). The PCF specifies a basket of securities and/or cash (the creation basket) that can be used to purchase shares of the non-taxable ETF on the next trading day. The financial instruments in the creation basket have a total value equal to the total value of the shares of the non-taxable ETF to be purchased. In a preferred embodiment, shares of the non-taxable ETF may only be purchased from the fund in large aggregates of (for example) many thousands of shares called a creation unit.

On the trading day (T+0), in step 710, a specialist authorized to trade shares of the non-taxable ETF receives the PCF from the NSCC or any distribution agent of the fund prior to the start of the trading day. The specialist's computer system may automatically load the PCF into a trading model in step 715 in order to determine in step 720 if there are any errors or ambiguities in the PCF, such as unknown symbols or illogical data. The errors or ambiguities in the PCF file are highlighted for resolution by trade support personnel for the specialists and market makers prior to the market open on day T+0. The specialist then loads the previous day's closing prices for the securities specified by the PCF in step 725 to calculate a value for the PCF, and compares that calculated value with the closing price of the non-taxable ETF prices prior to the opening of the exchange to ensure that they are reasonable.

When the exchange opens and throughout the trading day (T+0), the specialist conducts trades in shares of the non-taxable ETF as received from brokers authorized to trade shares of the non-taxable ETF in the manner described above with reference to FIG. 6. In step 735, because of the trading activity, the specialist must often maintain positions in (i.e., temporary ownership of or promises to sell) shares of the non-taxable ETF. If the demand for shares of the non-taxable ETF exceed the specialist's supply 740, then the specialist advises the non-taxable ETF's distributor and custodian of the need to create more shares 745. The specialist may then purchase shares of the securities specified by the PCF in step 750, and agree to deposit those securities with the fund in exchange for shares of the non-taxable ETF.

In step 755, the fund custodian and the specialist may affirm non-taxable ETF creation notices on the next trading day (T+1), and the NSCC serves as the central counterparty to the creation for both the fund and the specialist once all the trade facts are confirmed and affirmed. The NSCC then serves as a guarantor to the creation process at 12:01 a.m. on the second trading day (T+2). Finally, shares of the non-taxable ETF are delivered to the specialist by 9:30 a.m. by the NSCC on the third trading day (T+3).

FIG. 8 is a flow diagram illustrating one embodiment of a process for redemption of shares of a non-taxable (e.g., insurance) ETF. This diagram is for illustrative purposes only. Additional steps may be added, or some steps may be omitted or modified, without departing from the method of the invention. Furthermore, while the process described with respect to FIG. 8 uses non-taxable ETFs as an example, those with knowledge of the financial industry will appreciate that similar or identical processes may be used with other types of RFPs, especially with RFPs that are ETFs. Under typical circumstances, a specialist or arbitrageur will redeem shares of a non-taxable ETF if the net asset value of the ETF exceeds the market price of the ETF by more than the transaction cost of redeeming shares of the ETF.

In step 805, the investment manager of a non-taxable ETF sends a portfolio redemption file to the NSCC prior to 10 p.m. on the day before a trading day (T-1) for use in the purchase and redemption of shares of the non-taxable ETF on the trading day (T+0). While in general the portfolio redemption file may be different than the portfolio creation file (PCF) described above with reference to FIG. 7, in the embodiment of the redemption process depicted in FIG. 8, the portfolio redemption file is taken to be the same as the PCF. The PCF in this embodiment thus specifies a basket of securities and/or cash (the redemption basket) that will be provided by the fund when an equivalent value of fund shares are redeemed on the trading day. The financial instruments in the creation basket have a total value equal to the total value of the shares of the non-taxable ETF to be redeemed. In a preferred embodiment, shares of the non-taxable ETF may only be redeemed by the fund in large aggregates of (for example) many thousands of shares called a redemption unit.

On the trading day (T+0), in step 810, a specialist authorized to trade shares of the non-taxable ETF receives the PCF from the NSCC or any distribution agent of the fund prior to the start of the trading day. The specialist's computer system may automatically load the PCF into a trading model in step 815 in order to determine in step 820 if there are any errors or ambiguities in the PCF, such as unknown symbols or illogical data. The errors or ambiguities are highlighted for resolution by trade support personnel by 6:30 a.m. on day T+0. The specialist then loads the previous day's closing prices for the securities specified by the PCF in step 825 to calculate a value for the PCF, and compares that calculated value with the closing price of the non-taxable ETF prices prior to the opening of the exchange to ensure that they are the same.

When the exchange opens and throughout the trading day (T+0), the specialist conducts trades in shares of the non-taxable ETF as received from brokers authorized to trade shares of the non-taxable ETF in the manner described above with reference to FIG. 6. In step 835, because of the trading activity, the specialist must often maintain positions in (i.e., temporary ownership of or promises to sell) shares of the non-taxable ETF. If the specialist's inventory of shares of the non-taxable ETF exceed the demand 840, the specialist advises the non-taxable ETF's distributor and custodian of the need to redeem shares 845. The specialist may then redeem shares of the non-taxable ETF in exchange for the basket of securities specified by the PCF in step 850.

In step 855, the fund custodian and the specialist may affirm non-taxable ETF redemption notices on the next trading day (T+1), and the NSCC serves as the central counterparty to the creation for both the fund and the specialist. As a precaution, the NSCC may block the specialist from trading the non-taxable ETF inventory to be redeemed. The NSCC then serves as a guarantor to the redemption process at 12:01 a.m. on the second trading day (T+2). Finally, shares of the non-taxable ETF are delivered back to the fund, and the securities in the PCF are delivered to the specialist by 9:30 a.m. by the NSCC on the third trading day (T+3).

In some embodiments, the invention includes broker interface systems and methods to allow qualified customers to send orders to brokers to trade in RFPs (such as the proprietary system 155 in FIG. 1). For example, the broker interface may be through a computer website over the internet, through an automated telephone system, through an in-person telephone ordering system, by mail, or by any other ordering system known to those in the art. Once a customer places an order for an RFP such as a non-taxable (insurance) ETF, the broker interface may include a means, such as a computer means, for determining whether the customer is qualified to request a transaction involving the RFP. For example, if the customer submits an order to purchase shares of a non-taxable ETF, the interface may check the customer's account to verify that the funds the customer specifies for use to purchase the shares come from an insurance product. While the preferred embodiment uses a computer order interface and automated electronic computer verification of the customer's qualification to conduct the requested transaction, any means for verification may be used, including manual verification.

As will be immediately appreciated by those of ordinary skill in the art, modern exchange transactions involve communication among a number of computer systems. For example, a find company will have one or more computer systems to maintain account data and to send transaction data to exchanges and/or banks. Authorized participants, investors, brokers, specialists, and market makers likewise have one or more computer systems for keeping track of accounts and transactions and for sending data to other networked computer systems specifying details of requested transactions, including the identity of the security to be bought or sold, the number of shares to be bought or sold, and the price per share. Tri-party and custodian banks have one or more computer systems to receive data from outside computer systems and to maintain account databases. The NSCC likewise maintains computer systems to receive data from outside computer systems regarding the details of transactions and maintaining account databases. Public exchanges such as the American Stock Exchange maintain computer systems for automated order execution, account databases, and data transfer to outside computer systems. Any or all of these aforementioned systems may be involved in various aspects and embodiments of the present invention.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method to allow exchange-trading of financial products with restricted ownership rules, comprising:
receiving an order on a computer system to buy or sell shares of a financial product with restricted ownership rules, wherein the order is an electronic file comprising data indicating the identity of the financial product and the identity of the entity placing the order;
retrieving data from an electronic database, wherein the data from the electronic database contains information sufficient to determine, from among a plurality of entities and a plurality of restricted financial products, which entities are authorized to trade in which restricted financial products;
comparing the identity of the financial product and the identity of the entity placing the order with the data from the electronic database;
verifying that the entity placing the order is authorized to trade in the financial product with restricted ownership rules; and
electronically routing the order to a segregated trading area within the exchange, wherein only shares of the financial product with restricted ownership rules trade within the restricted trading area.

2. The method of claim 1, wherein the data from the electronic database comprises information about which firms are authorized to trade in the financial product with restricted ownership rules.

3. The method of claim 1, wherein the data from the electronic database comprises information about which firm branches are authorized to trade in the financial product with restricted ownership rules.

4. The method of claim 1, wherein the data from the electronic database comprises information about which brokers are authorized to trade in the financial product with restricted ownership rules.

5. The method of claim 1, wherein the financial product with restricted ownership rules is an exchange-traded insurance fund.

6. The method of claim 2, wherein a firm verifies that a customer placing an order to buy or sell shares of the financial product with restricted ownership rules is authorized to own shares of the financial product.

7. The method of claim 6, wherein the firm verifies that a customer placing an order to buy shares of the financial product with restricted ownership rules uses funds that are permitted for use to buy shares of the financial product with restricted ownership rules.

8. The method of claim 7, wherein the financial product with restricted ownership rules is an exchange-traded insurance fund, and the funds that are permitted for use to buy shares of the exchange-traded insurance fund are funds from an insurance annuity.

9. The method of claim 5, wherein a specialist fulfills orders for shares of the exchange-traded insurance fund, and wherein the specialist causes the creation of shares of the exchange-traded insurance fund when the specialist's inventory of shares of the exchange-traded insurance fund are insufficient to fill orders for shares of the exchange-traded insurance fund.

10. A system to allow exchange-trading of financial products with restricted ownership rules, comprising a computer system with:
an order receiving module for:
receiving an order on a computer system to buy or sell shares of a financial product with restricted ownership rules, wherein the order is an electronic file comprising data indicating the identity of the financial product and the identity of the entity placing the order;
an electronic database, wherein the data from the electronic database contains information sufficient to determine, from among a plurality of entities and a plurality of restricted financial products, which entities are authorized to trade in which restricted financial products;
a verification module for:
retrieving data from the electronic database,
comparing the identity of the financial product and the identity of the entity placing the order with the data from the electronic database; and
verifying that the entity placing the order is authorized to trade in the financial product with restricted ownership rules; and
an order routing module for:
electronically routing the order to a segregated trading area within the exchange, wherein only shares of the financial product with restricted ownership rules trade within the restricted trading area.

11. The system of claim 10, wherein the data from the electronic database comprises information about which firms are authorized to trade in the financial product with restricted ownership rules.

12. The system of claim 10, wherein the data from the electronic database comprises information about which firm branches are authorized to trade in the financial product with restricted ownership rules.

13. The system of claim 10, wherein the data from the electronic database comprises information about which brokers are authorized to trade in the financial product with restricted ownership rules.

14. The system of claim 10, wherein the financial product with restricted ownership rules is an exchange-traded insurance fund.

15. The system of claim 11, wherein the firm verifies that a customer placing an order to buy or sell shares of the financial product with restricted ownership rules is authorized to own shares of the financial product.

16. The system of claim 15, wherein the firm verifies that a customer placing an order to buy shares of the financial product with restricted ownership rules uses funds that are permitted for use to buy shares of the financial product with restricted ownership rules.

17. The system of claim 16, wherein the financial product with restricted ownership rules is an exchange-traded insurance fund, and the funds that are permitted for use to buy shares of the exchange-traded insurance fund are funds from an insurance annuity.

18. The system of claim 14, wherein a specialist fulfills orders for shares of the exchange-traded insurance fund, and wherein the specialist causes the creation of shares of the exchange-traded insurance fund when the specialist's inventory of shares of the exchange-traded insurance fund are insufficient to fill orders for shares of the exchange-traded insurance fund.

19. A computer software program product residing on a computer readable medium to allow exchange-trading of financial products with restricted ownership rules, comprising instructions for causing a computer system to:
receive an order to buy or sell shares of a financial product with restricted ownership rules, wherein the order is an electronic file comprising data indicating the identity of the financial product and the identity of the entity placing the order;
retrieve data from an electronic database, wherein the data from the electronic database contains information sufficient to determine, from among a plurality of entities and a plurality of restricted financial products, which entities are authorized to trade in which restricted financial products;
compare the identity of the financial product and the identity of the entity placing the order with the data from the electronic database;
verify that the entity placing the order is authorized to trade in the financial product with restricted ownership rules; and
electronically route the order to a segregated trading area within the exchange, wherein only shares of the financial product with restricted ownership rules trade within the restricted trading area.

20. The computer software program product of claim 19, wherein the data from the electronic database comprises information about which firms are authorized to trade in the financial product with restricted ownership rules.

21. The computer software program product of claim 19, wherein the data from the electronic database comprises information about which firm branches are authorized to trade in the financial product with restricted ownership rules.

22. The computer software program product of claim 19, wherein the data from the electronic database comprises information about which brokers are authorized to trade in the financial product with restricted ownership rules.

23. The computer software program product of claim 19, wherein the financial product with restricted ownership rules is an exchange-traded insurance fund.

24. The computer software program product of claim 20, wherein the firm verifies that a customer placing an order to buy or sell shares of the financial product with restricted ownership rules is authorized to own shares of the financial product.

25. The computer software program product of claim 24, wherein the firm verifies that a customer placing an order to buy shares of the financial product with restricted ownership rules uses funds that are permitted for use to buy shares of the financial product with restricted ownership rules.

26. The computer software program product of claim 25, wherein the financial product with restricted ownership rules is an exchange-traded insurance fund, and the funds that are permitted for use to buy shares of the exchange-traded insurance fund are funds from an insurance annuity.
